(19) United States
(12) Patent Application Publication
(10) Pub. No.: US 2007/0130224 A1
(43) Pub. Date: Jun. 7, 2007

(54) Deleting master data

(76) Inventors: Uwe E. Fischer, Karlsruhe (DE); Sijesh Manohar, Bangalore (IN); Sreekanth Babu, Bangalore (IN); Ramprasad Subramanian, Chennai (IN); Srinivas Ishwara Bhat, Bangalore (IN)

Correspondence Address: FISH & RICHARDSON, P.C., PO BOX 1022, MINNEAPOLIS, MN, 55440-1022, US

(21) Appl. No.: 11/361,468

(22) Filed: Feb. 24, 2006

(30) Foreign Application Priority Data
Nov. 22, 2005 (IN) 3124/DEL/2005

(51) Int. Cl. G06F 17/30

(52) U.S. Cl. 707/203

(57) ABSTRACT

Systems and techniques for deleting master data. In one implementation, a method includes identifying a version of a collection of master data to be deleted, publishing at least a portion of the version of the collection of master data from the client data processing system to a server in the data processing system landscape, deleting the version of the collection of master data from the client data, and ending management of the deleted version at the client. The version of the collection of master data to be deleted is stored by a client in a data processing system landscape that can manage multiple versions of the collection in the data processing system landscape.

### TECHNICAL FIELD

This disclosure relates to deleting master data in data processing landscape.

### BACKGROUND

Master data is information that is common to different locations and/or processes in a system landscape. Master data thus can be referenced by multiple systems and/or applications in a system landscape, such as, e.g., a product lifecycle management system, a customer relationship management system, a supply chain management system, and a manufacturing system. Master data thus may be shared across functional or other boundaries in an enterprise.

Master data can be stored in data objects. A data object is a collection of information that is grouped together and treated as a primitive in a data processing environment. A data object is generally free of internal references and information stored in a data object can be changed without concomitant changes to the data processing instructions that handle the data object. The information in a data object can be stored in a contiguous block of computer memory of a specific size at a specific location.

### SUMMARY

The disclosure describes systems and techniques for deleting master data at one or more locations in a data processing system landscape. In one implementation, a method includes identifying a version of a collection of master data to be deleted, publishing at least a portion of the version of the collection of master data from the client data processing system to a server in the data processing system landscape, deleting the version of the collection of master data from the client data, and ending management of the deleted version at the client. The version of the collection of master data to be deleted is stored by a client in a data processing system landscape that can manage multiple versions of the collection in the landscape.

This and other implementations may include one or more of the following features. The version of the collection of master data can be deleted from the client independently of consent by another data processing system in the system landscape. Subsequent requests involving the collection of master data can be responded to with a version of the collection of master data stored by the server. The collection of master data can be a master data object.

The version of the collection of master data can be deleted by preventing transactions involving the collection of master data other that master data auditing transactions and master data maintenance transactions and/or by closing the collection of master data to all subsequent changes.

In another implementation, an article can include a machine-readable medium storing instructions operable to cause one or more machines to perform operations. The operations can include storing two or more versions of a data object at two or more data processing systems in a system landscape, deleting a first version of the data object from a first data processing system in the system landscape while continuing use of one or more other versions of the data object at one or more other data processing systems in the system landscape, logging the deletion of the data object from the first data processing system at a server in the system landscape, and ending harmonization of the deleted version of the data object with the other versions of the data object. The data object is relevant to data processing activities at multiple data processing systems and the data stored in the two or more versions of a data object is harmonized according to the data processing activities at relevant data processing systems.

This and other implementations may include one or more of the following features. Subsequent requests involving data in the data object can be responded to using a second version of the data object stored by the server. The first version of the data object to be deleted can be identified based on a decreased relevance of the first version at the first data processing system. The first version of the data object can be deleted by preventing transactions involving the first data object other than master data auditing transactions and master data maintenance transactions.

The first data processing system can be the server. Deletion of a second version of the data object at a second data processing system in the system landscape can also be requested. A request from the server can be transmitted to the first data processing system requesting that the first version of the data object be deleted from the first data processing system.

In another implementation, an article can include a machine-readable medium storing instructions operable to cause one or more machines to perform operations. The operations can include providing versions of a master data collection to two or more clients in a data processing system landscape, identifying a first version of the master data collection to be deleted from a first client of the two or more clients, requesting deletion of the first version of the master data collection at the first client, and logging a denial of the request or a deletion of the version of the master data collection at the first client. The master data collection is relevant to data processing activities at the two or more clients and master data in the two versions is harmonized.

This and other implementations may include one or more of the following features. The operations can include providing services to the two or more clients using a server in the system landscape, wherein the master data collection is relevant to the services. Deletion of the first version of the master data collection can be requested from the server. Use of a second version of the master data collection can be continued at the second client in the system landscape. A second version of the master data collection can be deleted from the server. The first version of the master data collection to be deleted can be identified by determining the relevance of the version of the master data collection to the first client.

The details of one or more implementations are set forth in the accompanying drawings and the description below. Other features and advantages will be apparent from the description and drawings, and from the claims.

### DESCRIPTION OF DRAWINGS

FIG. 1 is a schematic representation of a distributed data processing system landscape.

FIG. 2 is a schematic representation of one implementation of the system landscape of FIG. 1.

FIG. 3 is a graph that illustrates an example of the relevance and the distribution of master data in different data processing system landscapes and devices.

FIG. 4 is a flowchart of a process for locally deleting a representation of a collection of master data.

FIG. 5 is a flowchart of a process for server-triggered local deletion of a representation of a collection of master data.

FIG. 6 is a flowchart of a third process for global deletion of a collection of master data.

FIG. 7 is a flowchart of a fourth process for deleting a collection of master data.

Like reference symbols in the various drawings indicate like elements.

### DETAILED DESCRIPTION

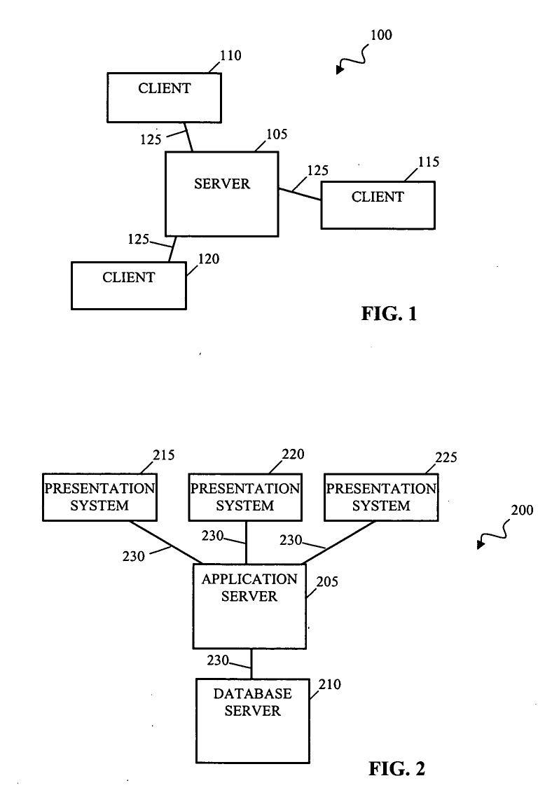

FIG. 1 is a schematic representation of a distributed data processing system landscape 100. A distributed data processing system landscape is a collection of data processing devices, software, and/or systems (hereinafter “data processing systems”) that operate autonomously yet coordinate their operations across a data communication link in a network. By operating autonomously, the data processing systems can operate in parallel, handling local workloads of data processing activities. The data communication link allows information regarding the activities, including the results of performance of the activities, to be exchanged between data processing systems. To these ends, many distributed data processing systems include distributed databases and system-wide rules for the exchange of data.

System landscape 100 is a collection of data processing systems that exchange information for the performance of one or more data processing activities in accordance with the logic of a set of machine readable instructions. System landscape 100 includes one or more servers 105 that are in data communication with a collection of clients 110, 115, 120 over a collection of data links 125.

Server 105 is a data processing system that provides services to clients 110, 115, 120. The services can include, e.g., the provision of data, the provision of instructions for processing data, and/or the results of data processing activities. The services can be provided in response to requests from clients 110, 115, 120.

Clients 110, 115, 120 are data processing systems that receive services from server 105. Clients 110, 115, 120 can also be responsible for other data processing activities, such as managing interaction with human users at their respective locations. Clients 110, 115, 120 can generate requests for such services and convey the requests to server 105 over one or more of data links 125.

Data links 125 can form a data communication network such as a LAN, a WAN, or the Internet. System landscape 100 can also include additional data links, including direct links between clients 110, 115, 120 and data links to systems and devices outside landscape 100, such as a communications gateway (not shown).

The roles of “server” and “client” can be played by the same individual data processing systems in system landscape 100. For example, the data processing system denoted as server 105 may receive certain services from one of clients 110, 115, 120. Thus, a data processing system may be a “server” in the context of a first set of services but a “client” in the context of a second set of services.

FIG. 2 is a schematic representation of one implementation of a system landscape, namely, a system landscape 200. System landscape 200 is a three tiered hierarchy of data processing systems and includes one or more application servers 205 and one or more database servers 210. Application server 205 and database server 210 are in data communication with each other and with a collection of presentation systems 215, 220, 225 over a collection of data links 230.

Application server 205 is a data processing system that provides administrative services to database server 210 and/or presentation systems 215, 220, 225. The administrative services can include, e.g., background processing, printing, and process request management. Application server 205 can also be a master data server. A master data server manages the use and distribution of master data in a system landscape. As such, a master data server can perform operations that include defining the content of master data, harmonizing the content in different in different systems, and distributing master data to different systems. For example, a master data server can be the target system for master data transfer and consolidation.

Database server 210 is a data processing system that provides storage, organization, retrieval, and presentation of instructions and data services to application server 205 and/or presentation systems 215, 220, 225.

Presentation systems 215, 220, 225 are data processing systems that receive services from application server 205 and database server 210. Presentation systems 215, 220, 225 can also manage interaction with human users at their respective locations, such as the display of information on a graphical user interface. Presentation systems 215, 220, 225 can generate requests for services and convey the requests to application server 205 and database server 210 over one or more of data links 230.

In system landscapes such as landscapes 100, 200, master data may be common to different data processing systems. In particular, master data may be relevant to data processing activities at the different data processing systems. For example, master data may be relevant to interaction with a user at client 110 and to application software at server 105. Master data may also be relevant to multiple applications at a single data processing device.

As a consequence of this widespread relevance of master data collections, multiple, corresponding versions of the collections of master data may be stored individually at different data processing systems in system landscapes 100, 200. Corresponding versions of the master data collections include at least some identical information and are maintained by master data management processes to ensure that this information remains harmonized at the different locations. However, the corresponding versions of the master data collections need not be identical. For example, a collection at one data processing device can be redacted based on the data processing activities commonly performed at that device or based on the data access rights that have been granted to users at that device.

Different versions of a master data collection can play different roles in a data processing system landscape. For example, a “master data entity” can store the complete content of a master data collection. A master data entity can thus be used as a system-wide source of data for other versions of a master data collection, as well as an early destination for changes in the master data. A master data entity can be stored by a server that manages data processing activities that involve the master data entity.

Another role that a version of a master data collection can play is that of a “master data representation.” A master data representation can be a version of a master data entity in a specific system in the data processing system landscape. A single master data entity can have multiple representations in the various systems, and in each system, in the landscape. A master data representation can be tailored to the requirements or other traits of a data processing system. For example, a master data representation can be a subset of a master data entity. A master data representation can be stored by a server or a client that manages data processing activities that involve the master data representation.

Every data processing system in a landscape need not store a version of every master data collection. For example, data storage at a server system can be limited to master data collections that are relevant to multiple clients, such as a master data entity. As another example, data storage at a client system can be limited to master data collections that are relevant to local data processing activities (i.e., data processing activities at that client system).

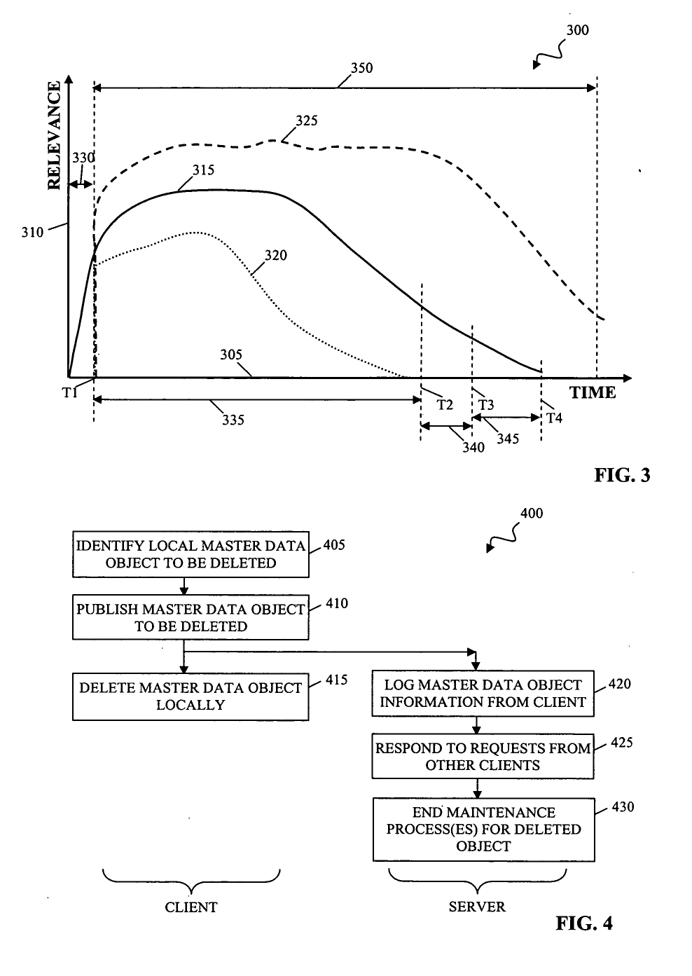

FIG. 3 is a graph 300 that illustrates examples of the relevance and the distribution of master data in three different data processing systems in a system landscape. Graph 300 includes a time axis 305 and a relevance axis 310 that frame curves 315, 320, 325. Time axis 305 indicates time since commencement of the gathering of a collection of master data. Relevance axis 310 indicates the relevance of the collection of master data in the various data processing systems. Curve 315 traces the relevance of one or more versions of the collection of master data to a first data processing system in the system landscape. The first data processing system is generally a client device in the system landscape. Curve 320 traces the relevance of one or more versions of the collection of master data to a second data processing system in the system landscape and curve 325 traces the relevance of one or more versions of the collection of master data to a third data processing system in the system landscape. The second and third data processing systems can be client and/or server devices in the system landscape. The collection of master data can be, e.g., a master data object.

Curve 315 originates at the origin of graph 300 with the commencement of the local operational state in the first data processing system. The master data is locally operative in that the local version of the master data collection is subject to various transactions in the first data processing system. These transactions can generally increase the amount of information stored in the master data collection. During a period of time 330, these increased amounts of information are gathered into the master data collection and the collection becomes increasingly relevant to the first data processing system.

At some time T1, the first data processing system completes some set of local operations and releases the collection for publication to other data processing systems in the data processing environment. The publication of the master data collection makes one or more versions of the master data collection available for data processing activities in the other data processing systems. The publication of the master data collection can include the duplication of all or a portion of the master data in corresponding versions of the master data collection at other data processing systems. For example, a master data entity can be established at a server (such as a master data server) in the system landscape and representations established at various clients in the landscape.

The publication of the master data collection can also include the establishment of communication and other protocols for managing subsequent changes to the master data. The protocols can define, e.g., which users are allowed to change master data in the collection and how changes are to be propagated through the system landscape. These protocols can be established and managed at a server such as a master data server.

After publication, the version(s) of master data collection are generally globally operative for a period of time 335. Globally operative master data is master data that is available for data processing activities throughout the system landscape. Globally operative master data may be changeable at only a single system or at two or more systems in the landscape. Globally operative master data is thus generally the subject of master data management activities such as master data replication, harmonization, and consolidation.

As can be seen, during time 335, the relevance of the master data need not be the same in every data processing system in the system landscape. Indeed, during time 335, the relevance of the master data can drop to zero in one data processing system (such as the second data processing system represented by curve 320) but yet the master data can remain globally operative. Further, the relevance of the master data can change over time in individual systems as different data processing activities are performed.

In general, over time, the relevance of the master data will have decreased to a level where the master data is largely irrelevant to many systems in the system landscape. At this level, automated replication processes and other master data management activities may be of decreased utility even when the master data remains relevant to, and changes may still be made in, one or more local data processing systems. An example of such a situation is the discontinuation of a commercial product. Data processing systems in an enterprise system landscape that are concerned with the development, manufacturing, and marketing of such a product may have little use for master data describing the product. However, the same master data may remain relevant to other systems in the enterprise system landscape, such as a vendor management system and a maintenance system.

When this occurs, at some time T2, a version of the master data collection can be marked for archiving at such data processing systems for a period of time 340. A version of a master data collection can be marked for archiving using a flag or other indicator that is associated with the collection. Master data that is marked for archiving can remain in the relevant data processing system and can remain public and globally operative in the system landscape. Master data that is marked for archiving can be audited, maintained, and synchronized with master data versions in other systems. Master data audits are performed to determine the effectiveness of master data storage in a system landscape. For example, master data audits can be performed to find and correct errors in master data or to determine the master data redundancy in a system or a system landscape. Master data maintenance can be performed, e.g., to harmonize and to consolidate master data across different data processing systems in a system or a system landscape. For example, changes to the master data collection in other data processing systems can be propagated to data processing system where the corresponding version of the master data collection that has been marked for archiving. Other transactions involving a master data collection that has been marked for archiving can be hindered or even foreclosed.

In some cases, the relevance of a master data collection that has been marked for archiving may increase rather than decrease (not shown). In these cases, the archive mark can be removed and the master data collection can be returned to global operative usage.

However, in many cases, at some time T3, the relevance of a master data collection has been marked for archiving will have further decreased in such systems. Such a master data collection can then be archived for deletion during a period of time 345. A master data collection that is archived for deletion can be locked and all subsequent changes, even those originating elsewhere, can be forbidden. Further, replication of a master data collection that has been archived for deletion can also be forbidden.

The decline in relevance, marking for archiving, and archiving for deletion of corresponding master data collections need not occur simultaneously in every data processing system in a system landscape. For example, as shown, corresponding versions of the master data collection can remain locally operative in the third data processing system represented by curve 325 for a period of time 350 that is longer than period of time 335.

At a time T4, simultaneously with or after the archiving of the master data collection for deletion, the master data collection can be deleted from the system where it is archived for deletion. Such a deletion marks the end of period of time 345. The deletion can occur while the master data collection is still relevant to the system where it is archived for deletion as shown, or after the master data collection is no longer relevant to the system where it is archived for deletion (not shown).

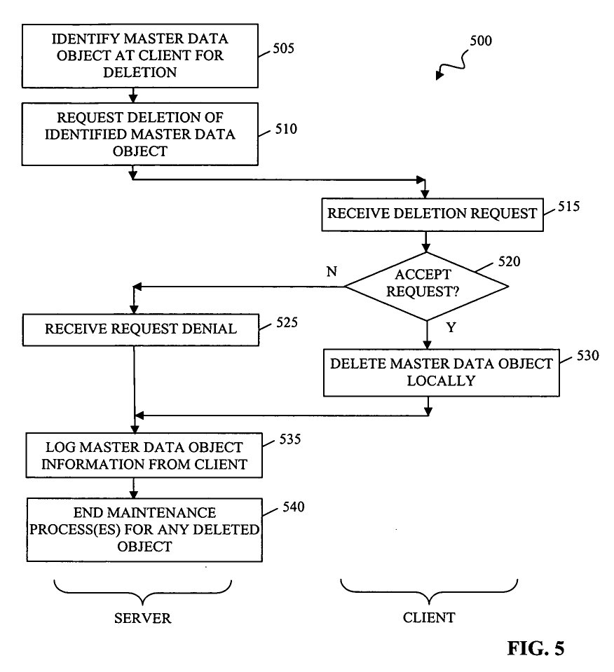

FIG. 4 is a flowchart of a first process 400 for deleting a collection of master data, namely a master data object. Process 400 can be performed in part by a client who is discontinuing usage of a master data object and in part by a server that provides one or more services to which the master data object is relevant. For example, the server can be a master data server. The version of the master data object to be deleted is stored at least at the client, and process 400 can be initiated by the client.

The client in which the master data object is to be deleted can identify the master data object that is to be deleted at 405. The master data object that is to be deleted can have certain characteristics that can be used in such an identification. For example, the master data object that is to be deleted can be marked by a flag or other indicator as archived for deletion, as discussed above. As another example, the master data object can be marked for archiving and a trigger or other indicator can spur an immediate deletion. As yet another example, the master data object that is to be deleted can be locally active at the client (and potentially globally active in the system landscape) but yet identified for deletion without being marked for archiving or archived for deletion.

The client in which the master data object is to be deleted can publish the master data object that is to be deleted to one or more systems in the system landscape at 410. Publishing can help ensure that corresponding versions of the master data objects in other systems are harmonized with the master data object that is to be deleted. For example, publishing can including copying all or a portion of the data in the master data object to be deleted into one or more systems in the system landscape. Publishing can also include redacting the master data object before such a copying. For example, data that has changed since a previous publication can be identified and this recently changed data can be copied. The systems to which the master data object to be deleted is published can include a server that provides services to which the master data object is relevant.

The client in which the master data object is to be deleted can delete the local version of the master data object at 415. Note that it may not be necessary for the owner of the master data object to receive permission or other authorization to delete the local version of the master data object. Rather, the owner may be authorized to proceed with such a deletion independently, i.e., without consent from elsewhere in the system landscape.

A server that provides services to which the master data object is relevant can log information regarding the master data object deletion at 420. Such a logging can include denoting the deleted master data object as deleted in a list or other record regarding data objects in the system landscape. Additional information regarding the status of corresponding versions of the deleted master data object can also be logged. For example, the transition of corresponding versions of the deleted master data object from globally operative to locally operative can be logged.

The server that provides services to which the master data object is relevant can respond to requests from other clients in the system landscape that involve the master data at 425. Such requests can include, e.g., access, audit, and maintenance requests. Such requests can be responded to using a version of the master data object that is stored by the server and that corresponds to the master data object deleted from the client.

The server that provides services to which the master data object is relevant can also end one or more maintenance processes for the deleted object at 430. When the server acts as a master data server for the deleted master data object, the maintenance processes can be ended by halting master data management activities performed for the client by the server. The maintenance processes can also be ended by informing a server that acts as a master data server for the master data object to halt such maintenance processes. The end of maintenance processes can include ending master data harmonization, replication, and/or consolidation.

FIG. 5 is a flowchart of a second process 500 for deleting a collection of master data, namely a master data object. Process 500 can be performed in part by a server that provides one or more services to which the master data object is relevant and in part by a client that performs data processing operations on the master data object. For example, the server can provide one or more services that relate to the global relevance of the master data object, such as master data management services. Process 500 can be initiated by the server and the master data object to be deleted can be stored by the client.

The server can identify a version of a master data object stored by a client for deletion at 505. The master data object to be deleted can be identified either individually or as a member of a class of data objects. The client that stores the version of the master data object that is to be deleted need not be identified when the version of the master data object is identified. For example, a name or a characteristic of a version of the master data object that is to be deleted can be identified independently of the name or characteristic of the client that stores the master data object.

The identified version of the master data object to be deleted can be a master data representation or a master data entity. When a master data entity is identified, a list or other description of clients where the deletion of corresponding local versions of the master data entity is desired can be used to identify the corresponding local versions for deletion.

Such an identification can be based on factors such as the relevance of versions of the master data object in one or more systems in the system landscape, the marking of a version of a master data object for archiving in one or more systems in the system landscape, the archiving a version of a master data object for deletion in one or more systems in the system landscape, or a prior deletion of a version of a master data object in one or more systems in the system landscape. For example, the prior deletion of a version of a master data object by a client using process 400 can be used to identify corresponding master data objects in the system landscape for deletion.

The server that provides one or more services to which the master data object is relevant can request deletion of the master data object at 510. Such a request need not be made to a specific client but rather can be broadcast to multiple clients in a system landscape. Further, such a request need not be made specific to an individual master data object or an individual master data entity but rather can simply include characteristics of one or more data objects whose deletion is requested.

A client that performs data processing operations on the version of the master data object whose deletion is requested can receive the deletion request at 515. If the deletion request only includes identifying information, the client can identify the version of the master data object whose deletion is requested and then determine whether to accept the request at 520. Such a determination can be made based on the relevance of the master data object to data processing activities at the client and the current status of the version of the master data object at the client. For example, the determination can be based on whether the version of the master data object has been marked for archiving or archived for deletion at the client.

If the client determines to deny the request, such a denial can be received at the server that made the request at 525. The server that made the request for deletion can log the denial of the request at 535.

On the other hand, if the client determines to accept the request at 520, the client can delete the version of the master data object locally at 530. Such a deletion can include marking the version of the master data object to be deleted for archiving, archiving the version of the master data object to be deleted for deletion, and/or publishing all or a portion of the version of the master data object to be deleted. For example, the client who accepts the request can perform all or a portion of process 400 (FIG. 4).

The server that made the request for deletion can log the deletion of the version of the master data object, along with the content of or any changes to the status of the version of the master data object, at 535. Additional information regarding the status of corresponding versions of the deleted master data object can also be logged. For example, the transition of corresponding versions of the deleted master data object from globally operative to locally operative can be logged.

The server that made the request for deletion can also end one or more maintenance processes for any object deleted by the client at 540. When the server acts as a master data server for the deleted master data object, the maintenance processes can be ended by halting master data management activities for the client performed by the server. The maintenance processes can also be ended by informing a server that acts as a master data server for the master data object to halt such maintenance processes. The end of maintenance processes can include ending master data harmonization, replication, and/or consolidation. If no object is deleted by the client, no change to the maintenance processes need be made.

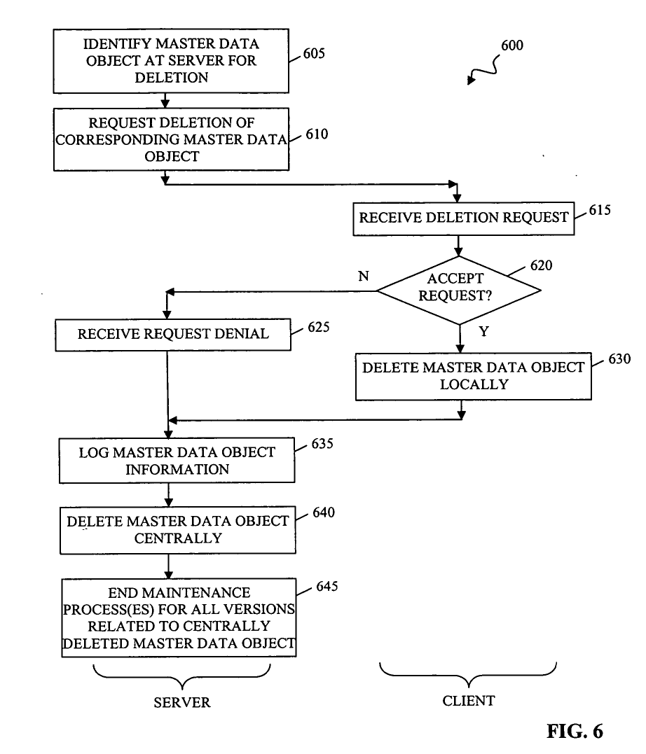

FIG. 6 is a flowchart of a third process 600 for deleting two or more corresponding versions of a collection of master data, namely a master data object stored by a server and one or more corresponding versions of this master data object stored at clients. Process 600 can be performed in part by such server and in part by one or more such clients. For example, process 600 can be performed by a master data server. In some implementations, process 600 can be used to delete every version of a master data object, including a master data entity and every master data representation in the system landscape. Process 600 is triggered by the server.

The server that stores a version of a master data object and provides one or more services to which the master data object is relevant can identify a master data object stored by the server for deletion at 605. The master data object to be deleted can be identified either individually or as a member of a class of data objects. The identified object can be, e.g., a master data entity.

Such an identification can be based on factors such as the relevance of a version of the master data object to data processing activities in the system landscape, the marking of a version of the master data object for archiving in one or more systems in the system landscape, the archiving a version of the master data object for deletion in one or more systems in the system landscape, or a prior deletion of a version of the master data object in one or more systems in the system landscape. For example, the version of the master data object to be deleted can be identified as a corresponding version of the master data object, such as a version of the master data object which has previously been deleted elsewhere in the system landscape, e.g., by one or more clients using a process such as process 400 (FIG. 4) or process 500 (FIG. 5).

The identification of the master data object stored by the server for deletion can include marking or otherwise indicating that the master data object is to be deleted. For example, the master data object stored by the server can be marked for archiving or archived for deletion at the server.

The server that provides one or more services to which the master data object is relevant can request deletion of a corresponding version of the master data object at 610. The request can be addressed to all clients that store versions of a particular master data object. A request need not be made specific to an individual master data object but rather can simply include characteristics of one or more corresponding master data objects whose deletion is requested.

The client(s) can receive the deletion request at 615. If necessary, a client can identify the corresponding version of the master data object whose deletion is requested and then determine whether to accept the request at 620. The corresponding version of the master data object whose deletion is requested can be a master data representation. The determination can be made based on the relevance of the master data object to data processing activities at the client and the current status of the corresponding version of the master data object at the client. For example, the determination can be based on whether the corresponding version of the master data object has been marked for archiving or archived for deletion at the client.

If a client determines to deny the request, such a denial can be received at the server that made the request at 625. The server that made the request for deletion can log the denial of the request at 635.

On the other hand, if a client determines to accept the request at 620, the client can delete the corresponding version of the master data object locally at 630. Such a local deletion can include marking the corresponding version of the master data object for archiving, archiving the corresponding version of the master data object for deletion, and/or publishing all or a portion of the corresponding version of the master data object. Further, such a local deletion can proceed using process 400 (FIG. 4).

The server that made the request for deletion can log deletion of the corresponding version of the master data object at 635. The server that made the request can also centrally delete the version of the master data object at the server at 640. The version of the master data object centrally deleted by the server can be a master data entity.

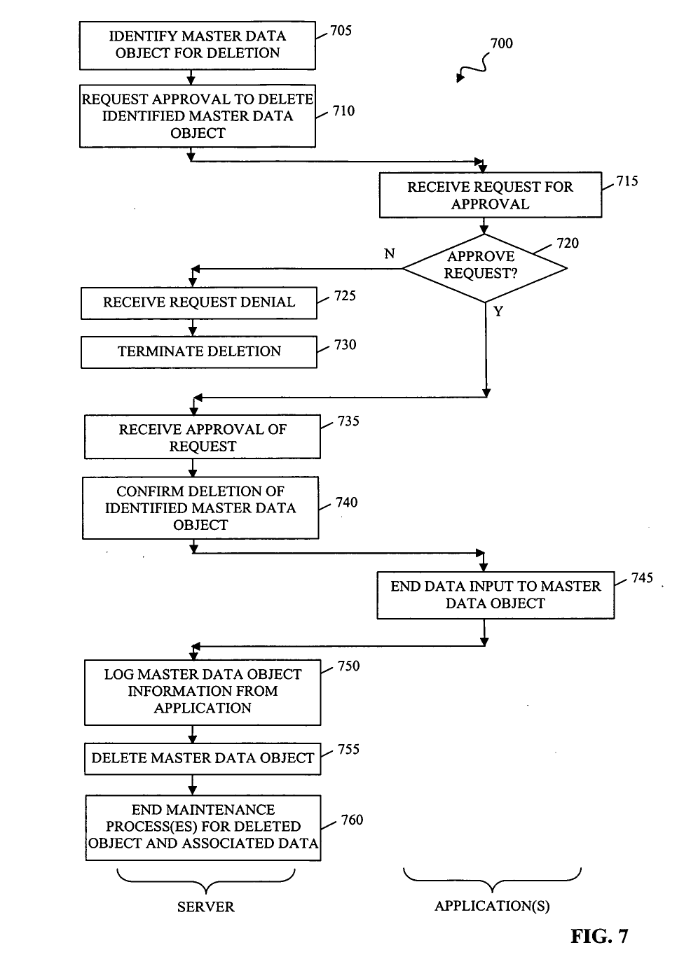

The deletion at the server can be proceed directly or the deletion can require coordination with other systems and/or applications in a data processing system landscape. For example, the server can send messages that request authorization to delete to other systems that perform data processing activities which involve corresponding versions of the master data object. If some portion (e.g., any) of the requests for authorization are denied, deletion at the server can be halted. On the other hand, if some portion (e.g., all) the requests for authorization are approved, deletion at the server can proceed. Additionally, in some implementations, the server can request approval to delete from applications using process 700 (FIG. 7).

The server that made the request for deletion can also end maintenance processes for all objects relating to the centrally deleted object at 645. These maintenance processes can, in some implementations, be ended regardless of whether the client(s) accepted or denied the deletion request. When the server acts as a master data server for the centrally deleted master data object, the maintenance processes can be ended by halting master data management activities performed by the server. The maintenance processes can also be ended by informing a server that acts as a master data server for the centrally deleted master data object to halt such maintenance processes. The end of maintenance processes can include ending master data harmonization, replication, and/or consolidation.

FIG. 7 is a flowchart of a fourth process 700 for deleting a collection of master data, namely a master data object. Process 700 can be performed in part by a server that provides one or more services to which the master data object is relevant and in part by a application that performs data processing operations on a version of the master data object. For example, the server can provide one or more services that relate to the global relevance of the master data object, such as master data management services. As another example, the application can be active on the server system. Process 700 can be initiated by the server and the master data object to be deleted can be stored by the server. Process 700 can be performed in conjunction with one or more of processes 400 (FIG. 4), 500 (FIG. 5), and 600 (FIG. 6).

The server can identify a version of a master data object at the server for deletion at 705. The server can also request approval to delete the identified master data object from one or more applications at 710. The request for approval can be sent to applications that input data into the identified master data object. The request for approval can identify the object by name, by class, or by other identifying information.

The application(s) from which approval is requested can receive the request at 715 and determine whether to approve the request at 720. The determination can be based on the relevance of the data object to data processing activities performed by the applications. The determination can also be based on the status of the master data object or of corresponding versions of the master data object in the system landscape.

If the request for approval is denied, a request denial can be received by the server at 725. The server can terminate deletion of the identified master data object at 730. In some implementations, if approval to delete is requested from multiple applications, a denial of the approval by a single such application can lead to a termination of the deletion of the identified master data object.

If the request for approval is approved, the server can receive the approval at 735 and confirm that deletion of the identified master data object is to proceed at 740. The application(s) can receive this confirmation and end data input into the master data object, or one or more versions of the master data object, at 745. The application(s) can publish any previously unpublished data and/or an indication of the change in status of the interactions with the master data object by the application(s). Any such publication can be logged by the server at 750.

The server can delete the master data object at 755 and end maintenance processes for the deleted object at its associated data at 760.

Various implementations of the systems and techniques described here can be realized in digital electronic circuitry, integrated circuitry, specially designed ASICs (application specific integrated circuits), computer hardware, firmware, software, and/or combinations thereof. These various implementations can include one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) may include machine instructions for a programmable processor, and can be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

A number of implementations have been described. Nevertheless, it will be understood that various modifications may be made. For example, the steps in various processes can be performed in different order and useful results can still be obtained. For example, step 640 can be performed between steps 605 and 610 (FIG. 6).

Also, processes 400, 500, and 600 can be performed with collections of master data other than master data objects. Accordingly, other implementations are within the scope of the following claims.

What is claimed is:

1. A method comprising:
identifying a version of a collection of master data to be deleted, wherein the version is stored by a client in a data processing system landscape that can manage multiple versions of the collection in the data processing system landscape;
publishing at least a portion of the version of the collection of master data from the client data processing system to a server in the data processing system landscape;
deleting the version of the collection of master data from the client data; and
ending management of the deleted version at the client.

2. The method of claim 1, wherein the version of the collection of master data is deleted from the client independently of consent by another data processing system in the system landscape.

3. The method of claim 1, further comprising responding to subsequent requests involving the collection of master data with a version of the collection of master data stored by the server.

4. The method of claim 1, wherein the collection of master data comprises a master data object.

5. The method of claim 1, wherein deleting the version of the collection of master data comprises preventing transactions involving the collection of master data other that master data auditing transactions and master data maintenance transactions.

6. The method of claim 1, wherein deleting the version of the collection of master data comprises closing the collection of master data to all subsequent changes.

7. An article comprising a machine-readable medium storing instructions operable to cause one or more machines to perform operations comprising:
storing two or more versions of a data object at two or more data processing systems in a system landscape, wherein the data object is relevant to data processing activities at multiple data processing systems and the data stored in the two or more versions of a data object is harmonized according to the data processing activities at relevant data processing systems;
deleting a first version of the data object from a first data processing system in the system landscape while continuing use of one or more other versions of the data object at one or more other data processing systems in the system landscape;
logging the deletion of the data object from the first data processing system at a server in the system landscape; and
ending harmonization of the deleted version of the data object with the other versions of the data object.

8. The article of claim 7, wherein the operations further comprise responding to subsequent requests involving data in the data object using a second version of the data object stored by the server.

9. The article of claim 7, wherein the operations further comprise identifying the first version of the data object to be deleted based on a decreased relevance of the first version at the first data processing system.

10. The article of claim 7, wherein deleting the first version of the data object comprises preventing transactions involving the first data object other than master data auditing transactions and master data maintenance transactions.

11. The article of claim 7, wherein the first data processing system comprises the server.

12. The article of claim 7, wherein the operations further comprise requesting deletion of a second version of the data object at a second data processing system in the system landscape.

13. The article of claim 7, wherein the operations further comprise transmitting a request from the server to the first data processing system requesting that the first version of the data object be deleted from the first data processing system.

14. An article comprising a machine-readable medium storing instructions operable to cause one or more machines to perform operations comprising:
providing versions of a master data collection to two or more clients in a data processing system landscape, wherein the master data collection is relevant to data processing activities at the two or more clients and master data in the two versions is harmonized;
identifying a first version of the master data collection to be deleted from a first client of the two or more clients;
requesting deletion of the first version of the master data collection at the first client; and
logging a denial of the request or a deletion of the version of the master data collection at the first client.

15. The article of claim 14, wherein the operations further comprise providing services to the two or more clients using a server in the system landscape, wherein the master data collection is relevant to the services.

16. The article of claim 15, wherein deletion of the first version of the master data collection is requested from the server.

17. The article of claim 15, wherein the operations further comprise continuing use of a second version of the master data collection at the second client in the system landscape

18. The article of claim 15, wherein the operations further comprise deleting a second version of the master data collection from the server.

19. The article of claim 14, wherein identifying the first version of the master data collection to be deleted comprises determining the relevance of the version of the master data collection to the first client.
